(19) United States
(12) Patent Application Publication
(10) Pub. No.: US 2009/0132404 A1
(43) Pub. Date: May 21, 2009

(54) APPORTIONING FRAUD LIABILITY

(76) Inventors: Marie King, San Carlos, CA (US); Tim Murphy, San Mateo, CA (US); David A. Van Horn, Danville, CA (US); Curtis Yee, Redwood City, CA (US)

Correspondence Address: Quarles & Brady LLP, TWO NORTH CENTRAL AVENUE, One Renaissance Square, PHOENIX, AZ, 85004-2391, US

(21) Appl. No.: 11/944,091

(22) Filed: Nov. 21, 2007

(51) Int. Cl. G06Q 40/00

(52) U.S. Cl. 705/35

(57) ABSTRACT

After receiving a notice as to the occurrence of an unauthorized access to financial account information for one or more accounts sufficient for completing one or more financial transactions using the financial account information, a financial service provider assesses the liability for the particular compromise event by analyzing the industry-wide distribution of fraud that would have occurred had the compromise event not occurred, and calculates an incremental amount of fraud that accrued as a result of the compromise event. The incremental fraud is then apportioned to the responsible parties.

### BACKGROUND

The present invention relates generally to financial transactions, and more particularly, to apportioning liability for fraudulent transactions in a financial system.

The credit card industry, created over twenty-five years ago, has been a boon to consumers and merchants alike. Credit cards allow consumers to make purchases when other methods of tender are either inconvenient or impossible to use under the circumstances. However, the credit card industry is not without potential financial hazards—although significant strides have been made to enhance the security of transactions and protect account-related information, fraud still remains a major concern and expense.

Turning to FIG. 1, a diagram illustrating financial transaction system is provided to assist in understanding a typical financial transaction scenario involving a credit card. By way of nomenclature, drawing elements 120, 130, 140 in FIG. 1 are illustrated with a single box, but indicate one or more elements as the indicated subscripts apply. For example, Issuer (j) 140 is one of a possible plurality of issuers, where j may range from 1 to an unlimited number.

Cardholder 130 presents a credit card to a Merchant 120 (at step 145) as tender for a financial transaction such as a purchase of goods. As part of the transaction, the Cardholder's 130 credit card is typically scanned or swiped through a magnetic card reader by the Merchant 120, whereupon account information is read from the card and a request for authorization is transmitted to the Merchant's Acquirer 110 (at step 155). Acquirers are financial organizations that process credit card transactions for businesses (e.g. merchants) and are licensed as members of a credit card association such as Visa. As such, acquirers establish a financial relationship with their merchants, and assist in preventing and reporting fraudulent transactions and security-related events. The Acquirer 110 transmits the account information to the transaction handler, or Financial Service Provider (or “FSP”) 100 (at step 165), who in turn routes the request to the Cardholder's issuing bank, or Issuer 140 (at step 170). The Issuer 140 returns authorization information to the Financial Service Provider 100 (at step 170) who returns the information to the Merchant 120 through the Acquirer 110. The Merchant, 120, now knowing whether the Issuer's 140 credit card account is valid and supports sufficient balance, may complete the transaction and the Cardholder 130 in turn receives goods and/or services in exchange (at step 150). Most credit card associations instruct merchants that after receiving authorization, the detailed credit card account information obtained from the point of sale magnetic stripe scanner must be deleted.

To reconcile the financial transactions and provide for remuneration, information about the transaction is provided by the Merchant 120 to Acquirer 110 (at step 155), who in turn routes the transaction data to the Financial Service Provider 100 (at step 165) who then provides the transaction data to the appropriate Issuer 140 (at step 170). The Issuer then provides funding for the transaction to the Financial Service Provider 100 (at step 175) through a settlement bank (not shown). The funds are then forwarded to the Merchant's Acquirer 110 (at step 180) who in turn pays the Merchant 120 for the transaction (at step 160), (less a merchant discount, if applicable). The Issuer 140, then bills the Cardholder 130 (at step 185), and the Cardholder 130 pays the Issuer 140 (at step 190), with possible interest or fees.

Many credit card companies have identified critical security guidelines that, if followed rigorously, reduce or eliminate altogether most forms of fraud. Yet, as in any system where human interaction is a factor, security guidelines are not always followed. For example, many credit card companies mandate that after transactions have been authorized, merchants must not store detailed account information obtained by scanning the magnetic stripes on customer credit cards. However, merchants may not always follow this rule, and as a result, account information may be stolen from merchants who accumulated and retained information from point of sale terminals. With the advent of computer networks, the account compromise problem is compounded by the ability of hackers to surreptitiously enter a merchant's computer system and obtain credit card account information without detection.

Once account information has been compromised through unauthorized direct access to stored data or unauthorized network entry, card data may be used to perpetrate fraud on any number of merchants. For example, hackers or data thieves may use the fraudulently-obtained data to create counterfeit credit cards from card blanks or stolen cards. Once such cards have been programmed with legitimate account information, persons producing such cards at time of purchase appear to be legitimate account holders, at least until account numbers are suspended or cancelled through a report of theft or fraud. However, a significant period of time may elapse from the unauthorized acquisition of account data until the nature of the data theft is discovered. During this time, massive amounts of fraud may occur; especially when data involving thousands or millions of account numbers may be stolen during any particular account compromise event.

Once account compromise has been discovered, instructing card issuers to cancel or refuse authorization for transactions is only part of the problem. The financial aftermath of the compromise event needs to be addressed, particularly from assigning liability to the appropriate parties and ensuring that fair and equitable remuneration occurs. In the past, resolving the issue of liability and operational expense reimbursement may have required examination of voluminous records in an attempt to determine liability for each potentially fraudulent transaction that arose from magnetic stripe counterfeit fraud (or MSCF). This process required enormous investments in time and human capital and may have resulted in an inconsistent approach to assigning liability to the interested parties. Further, card issuers are concerned that they not only be remunerated for their liability for the fraudulent transactions, but also for the added expense in customer service and re-issuance of cards to the affected card holders.

What is needed, then, is a system to receive notice and information related to an account compromise event and provide an efficient method to allocate liability to affected parties. What is also needed are cost- and time-efficient methods to assist in compensating card issuers for the added customer service resulting from fraudulent transactions that do not otherwise impair the economics of card re-issuance. What is also needed is a method of allocating liability that incentivizes participating parties to quickly report suspected financial fraud or data compromise events.

### SUMMARY

A system receives and processes information relating to financial accounts that have been compromised by unauthorized access to account information, and assign liability to the appropriate parties. One form of compromise event may involve unauthorized acquisition of credit card magnetic stripe data that had been scanned and stored by a merchant. Transactions related to the compromise event are analyzed and compared to industry-wide fraud rate distributions, and conclusions are drawn regarding whether fraudulent transactions associated with accounts involved in the compromise were a result of the compromise event or would have occurred despite the compromise event. After determining that an additional or incremental amount of fraud occurred as a result of the compromise event, an aggregate liability figure may be calculated and assigned to the affected entity.

In one implementation, once a merchant notifies their acquirer of an account compromise event, the acquirer transmits via a secure interface the stolen account numbers that in turn are stored directly to a secure database. The transaction handler or financial service provider (or “FSP”) then investigates and verifies that an account compromise had occurred. Affected users are notified of the compromised accounts, and affected issuers take appropriate actions such as monitoring, closing, or blocking the compromised accounts.

The financial service provider reviews information and transactions related to the compromise event, and determines whether to apply an embodiment of the incremental fraud analysis of the present invention. If the FSP decides that the validated account compromise meet certain, criteria, it calculates and advises the acquirer of its potential financial liability, which may include a percentage of fraud liability such as magnetic stripe-read counterfeit fraud and partial operating expense liability amounts. As an example, the magnetic stripe-read counterfeit fraud estimate may be based on the magnetic stripe-read counterfeit fraud that has been reported at the time of the notice and includes an estimation of fraud that is projected to occur prior to the end of an event window, but has yet to be reported as fraud.

In another implementation, an acquirer has a predetermined period of time (such as 30 days) to appeal the preliminary liability decision to the financial service provider for consideration. After the event window has passed, a predetermined period of time (such as 90 days) is also provided for issuers to submit any final fraud reports. If the event still meets established criteria at the end of the issuers' opportunity to submit fraud reports, the financial service provider calculates the attributed fraud and operating expense liability amounts due each participating issuer impacted by the compromise. In yet another implementation, acquirers choose how to notify their merchants about estimated and final liability amounts.

### BRIEF DESCRIPTION OF THE DRAWINGS

The features and advantages of implementations of the disclosure will become more apparent from the detailed description set forth below when taken in conjunction with the drawings, in which like elements bear like reference numerals:

FIG. 1 depicts a prior art diagram of a financial service provider in one embodiment of a process for authorizing and remunerating credit card transactions;

FIG. 2 illustrates a block and flow diagram of the teachings of the present system, showing at least one type of compromise event;

FIG. 3 illustrates a flow diagram depicting an overview of the teachings of a fraud liability apportionment process;

FIG. 4 depicts a flow diagram of the teachings of a method of the present invention; and

FIG. 5 depicts the continuation of the flow diagram beginning in FIG. 4;

FIG. 6 depicts a graph showing one exemplary distribution of magnetic stripe fraud to all fraud types exclusive of fraud related to a compromise event;

FIG. 7 depicts a graph showing one exemplary distribution of magnetic stripe fraud to all fraud types inclusive only of fraud related to a single compromise event; and,

FIG. 8 depicts a graph showing the two prior exemplary distributions from FIGS. 6 and 7 superimposed.

### DETAILED DESCRIPTION

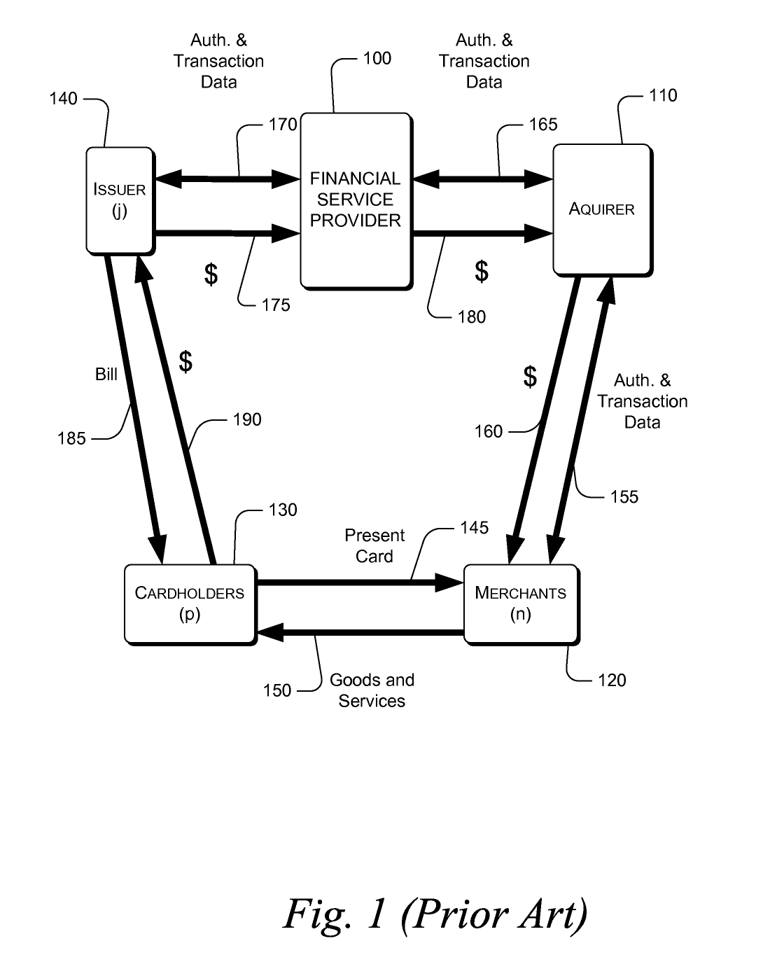

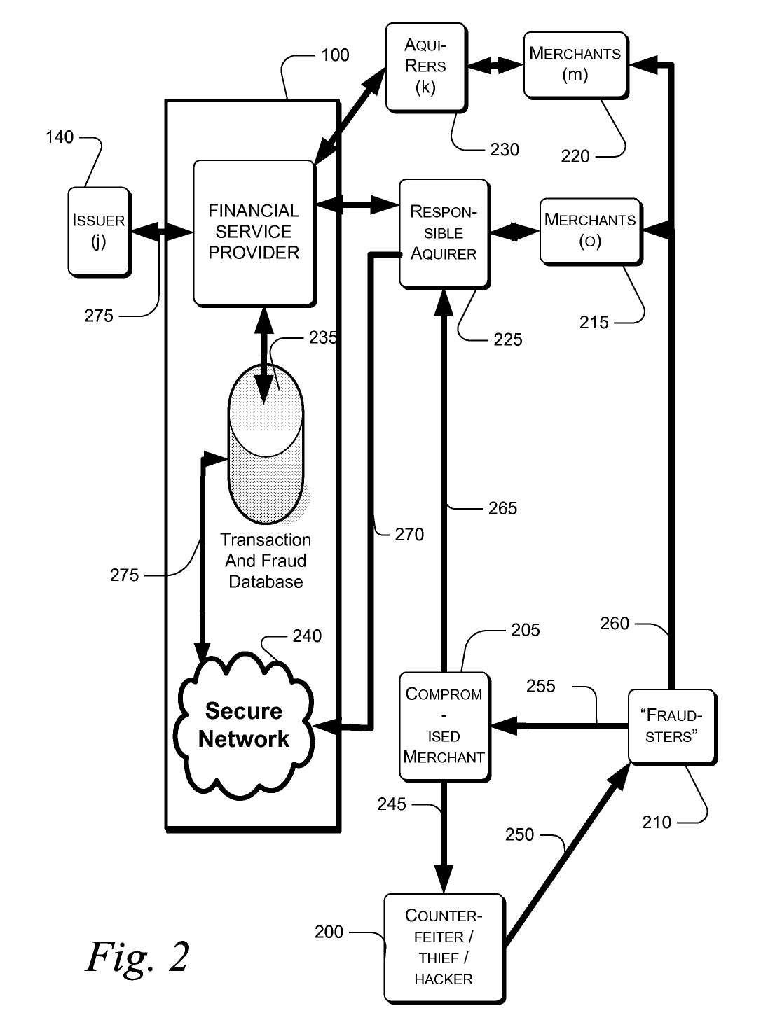

Turning to FIG. 2, a diagram illustrates an implementation. Similar to FIG. 1, flow lines indicating a financial transaction are depicted, but with elements illustrating how one type of fraud may occur as a result of a compromise event. While a credit card transaction system will be described in regards to FIGS. 2-5, those of skill in the art also recognize that other financial instruments may be used for tender in lieu of credit cards, including, but not by way of limitation, ATM cards, debit cards, money orders, gift cards, wire transfer orders, travelers cheques, or combinations of the above. Indices (k), (m), and (o), in regards to Acquirers (k) 230, Merchants (m) 220, and Merchants (o) 215, respectively, indicate a possible plurality of such entities, where indexes, k, m, and o may range from 0 to infinity.

A Merchant 205 who stores financial account information from sales transactions is vulnerable to a compromise event. Such an event may arise from an employee making copies of stored account information that had been derived from credit card magnetic stripe scans, or from a hacker accessing the Merchant's scanned account information database through a network connection such as the Internet. As a result, detailed account information is taken 245 from the Merchant 205 by a Thief 200 (such as a counterfeiter, hacker, or the like). Typically the detailed account information is then used by the Thief 200 to manufacture counterfeit cards by programming magnetic stripes on new blank credit cards or reprogramming stolen credit cards (at step 250). The cards are then used by parties 210 wanting to perpetrate fraud by presenting the cards as tender (at steps 255 or 260) for what appears to Merchants 205, 215, 220 to be legitimate transactions. One reason why counterfeit cards may be used successfully is that there may be a significant period of time that elapses from the moment the account data is compromised (at step 245) to a time when a report of compromise or analysis of fraud patterns indicates that the accounts have been compromised. In the interim, parties 210 may use the cards to make many fraudulent transactions, of the type referred to herein as magnetic stripe counterfeit fraud (“MSCF”). Those of skill in the art recognize that MSCF is only one type of fraud among many types of financial fraud perpetrated in credit card financial transactions. For example, but not by way of limitation, among other credit card fraud types are lost card fraud, stolen card fraud, fraud for cards not received in the mail, fraud arising from fraudulently completed applications, account takeover, and card not present fraud (e.g. fraudulent use of an account number, for instance, through a phone order).

Once MSCF-type fraud has been perpetrated, at some point the Merchant 205 who was a victim of the compromise may report the compromise event to the Merchant's Acquirer 225 (at step 265), who may, in one embodiment, ultimately be assigned liability for MSCF-type fraud that occurs as a result of the compromised account data. The Responsible Acquirer 225 then contacts the Financial Service Provider 100, and uploads through a secure network connection 240 the account information for the compromised accounts (at step 270). The date of the report is recorded as part of the process. The account data provided to the Financial Service Provider 100 is stored 275 in a secured database 235 that is maintained by the transaction handler or provider 100, and is accessible in a limited fashion to Issuers 140, Acquirers 230, 225, the Compromised Merchant 205, and to law enforcement officers (not shown).

Upon receiving notice of the compromise, the Financial Service Provider 100 provides notice 276 to the affected Issuers 140, that is, to Issuers who have issued accounts that appeared among the list of compromised accounts. The Issuers 140 then may take the appropriate action such as blocking additional transactions, contacting cardholders for questionable transactions, handling dispute issues, and re-issuing cards. As those of skill in the art understand, the customer service burden from MSCF-type fraud imposed upon the Issuers 140 is significant. Therefore part of the Issuer's 140 overhead expense liability may, in one embodiment, be assigned on a flat-fee per-compromised-account basis to the Responsible Acquirer 225, who will then be obligated to provide at least partial reimbursement.

After notice of the compromise event is received by the Financial Service Provider 100, a process begins to establish what fraud, if any, has occurred as a direct result of the compromise event. In prior art approaches, analysis was conducted on a transaction-by-transaction basis to determine which transactions qualified for fraud handling and individual determinations were made as to liability for the fraudulent amounts. However, in an implementation, data is analyzed by the Financial Service Provider 100 from composite databases (transaction and fraud database 235) that comprises the reported financial fraudulent transactions and account information, overall industry-wide financial transaction information (not shown), and Issuer account databases (not shown). Those of skill in the art recognize that the disparate data sources may be accessed by the Financial Service Provider 100 by a computerized process of retrieving and processing data under the FSP's control.

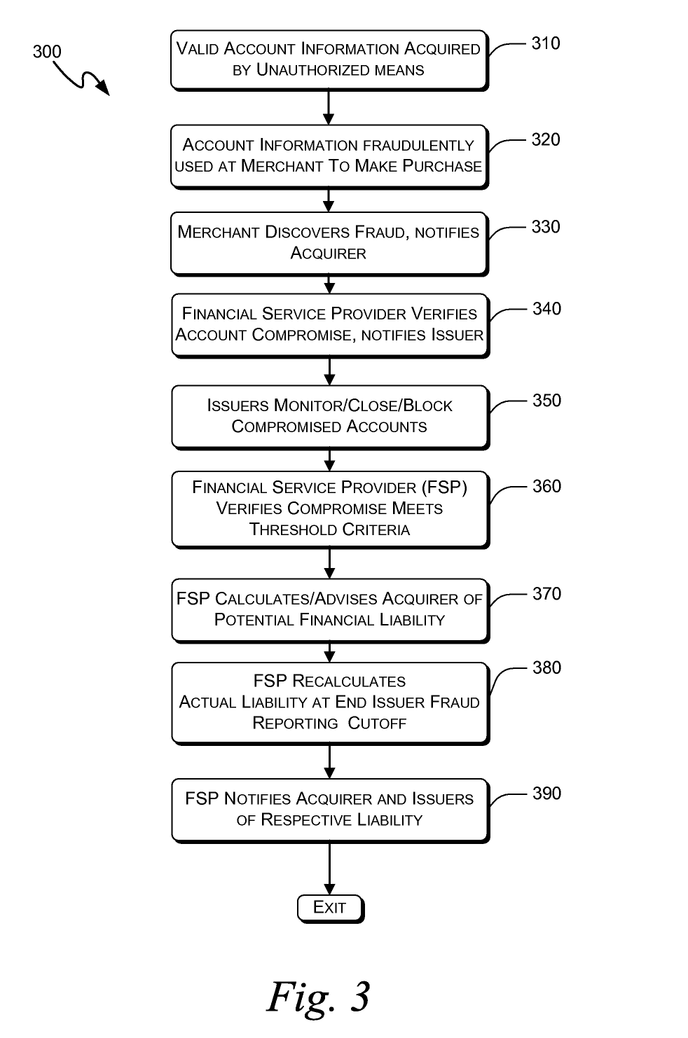

Turning to FIG. 3, flow chart 300 depicting an overview of an embodiment of the liability allocation process is presented. As mentioned previously, MSCF-type fraud begins with valid account information being acquired through unauthorized means 310 such as physically copying data or by unauthorized transmission through a network. The account information is then used at step 320 by Fraudusters (FIG. 2, 210) to make purchases at merchants. Once a compromised merchant discovers that data was compromised, the merchant then informs the merchant's acquirer 330, who then provides information about the compromise event (including at least the account numbers compromised) to the Financial Service Provider 100. Note that while the above process is described with the merchant first discovering the compromise or originating the compromise report, it is also possible that another entity first discovers or reports the account compromise event. The FSP 100 then analyzes the information and notifies the issuers of the compromised accounts 340 so that the Issuers may take steps mitigate the MSCF-type fraud, such as by monitoring, closing, and/or blocking access to compromised accounts 350.

The FSP 100 considers the nature, timing, and extent of the account compromise event, and determines whether certain threshold criteria are satisfied that would qualify the event for analysis under an implementation (step 360). For example, but not by way of limitation, the FSP could determine that the following criteria should be satisfied for continued analysis to be performed: (1) the compromise event involved at least a minimum number of accounts (such as 10,000 or more accounts); and (2) incremental MSCF is attributed to the compromise event. If the criteria are determined to be satisfied, the FSP continues to calculate and advise the responsible acquirer (and issuers, if applicable) as to the potential amount of financial liability to be assigned as a result of the compromise (at step 370). At the end of an issuer fraud reporting cutoff period, the FSP recalculates a final fraud liability amount (and ratio) 380 and communicates the liability amounts to the applicable acquirer and issuers 390.

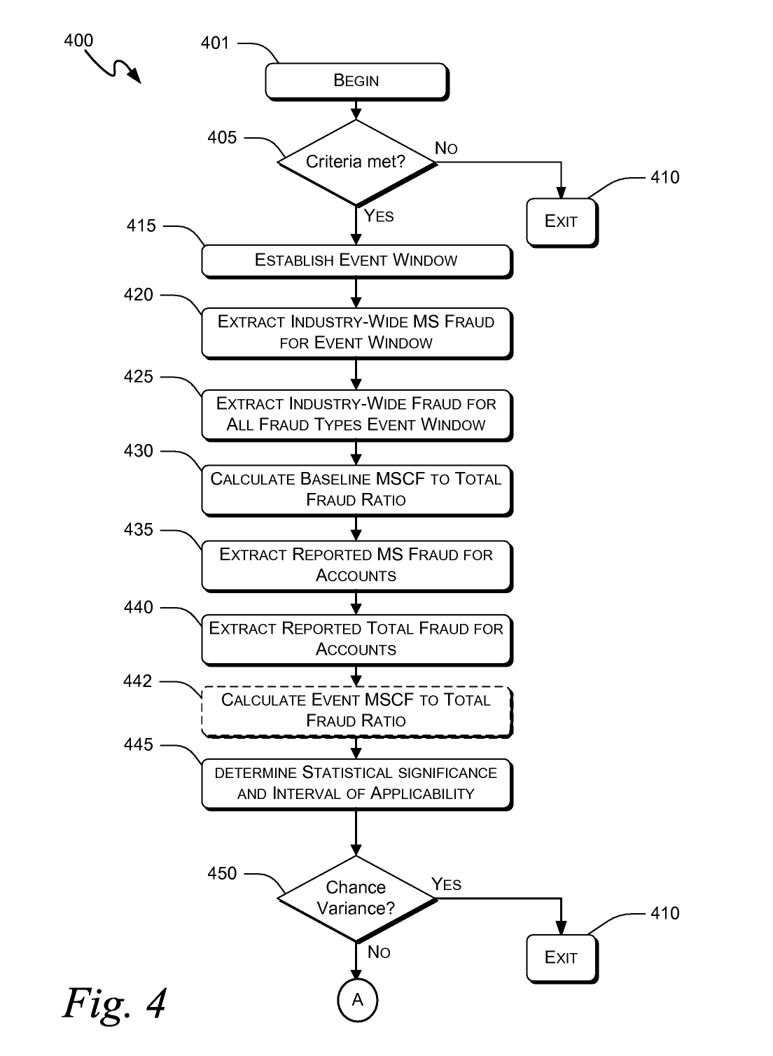

Turning now to FIG. 4, a more detailed flowchart 400 of a portion of the liability calculation and apportionment method is depicted. As discussed in relation to FIG. 3, the process begins after a report of a compromise event had been made, and the financial service provider conducts an inquiry into whether a method implementation should be utilized to apportion fraud (at step 401). If criteria are not satisfied (step 405), then the process terminates (step 410). Assuming that the criteria are satisfied, the process continues with the establishment of an event window (at step 415). An event window is a continuous period of time beginning before the date the compromise event was reported and continuing until some period of time on or after the report date. The window serves as a time reverence for analyzing data relating to the compromise event; fraudulent transactions occurring before the event window or after the event window do not enter into liability apportionment calculations. For example, but not by way of limitation, an event window could begin 12 months before a report date, and extend to one month after a report date. While the periods of time before and after the report date may be predetermined, those of skill in the art recognize that the event window may be adjusted to meet certain goals, such as capturing a quantified amount of MSCF, incentivizing the reporting of compromise events, limitation of acquirer liability, or some combination of factors. For example, to motivate merchants and acquirers to quickly submit compromise reports, designing the window period to have a relatively short post-reporting period compared to a longer pre-reporting period reminds the acquirers/merchants that the earlier a compromise situation is reported, the sooner the event window is fixed, and the less liability exposure an acquirer will be assigned (due, in part, to the typical latency from the compromise event until actual fraudulent transactions begin to be detectable). Those of skill in the art may recognize that dates other than the compromise reporting date may be used to set the event window to achieve similar or other goals.

After the event window is established, a first set of data is extracted from a database 420, where the data represents industry-wide fraud of MSCF-type that occurred during the event window period. A second set of data is extracted from a database 425, and this data set represents industry-wide fraud of all fraud types that occurred during the event window period. From both sets of data extracted during steps 420 and 425, certain fraudulent transactions may be excluded from each data set, namely those transactions that involve account numbers that were accessed during the compromise event. The fraudulent transaction data extracted in both cases may comprise at least the amount of fraud, fraud type, and date of occurrence for each fraudulent transaction; or an aggregate of these factors may be extracted or classified by time period (e.g. aggregated by month of occurrence).

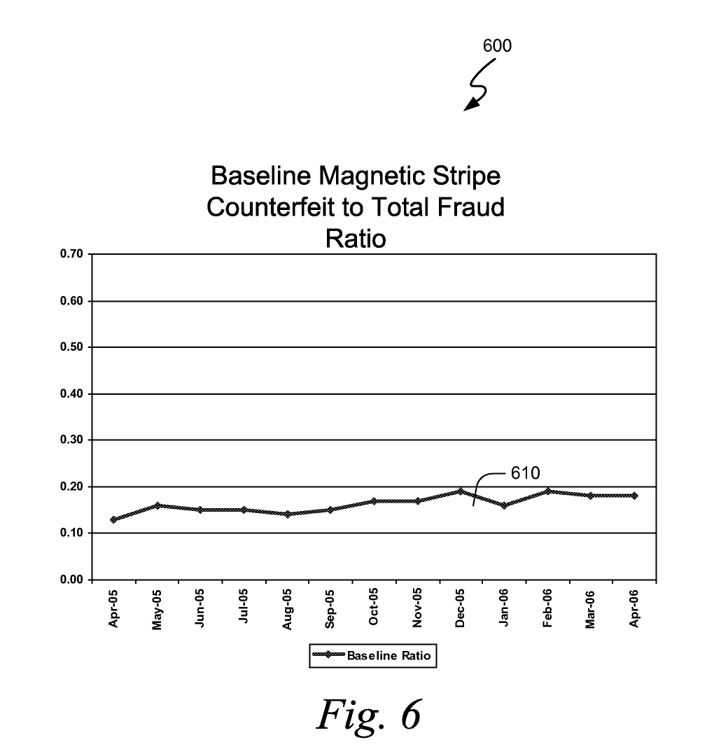

A ratio is computed that describes the ratio or distribution of an industry baseline MSCF-type fraud to all type frauds reported in the industry (step 430), exclusive of fraud committed outside of the event window and exclusive of fraud involving accounts compromised during the compromise event. In one embodiment, the data extracted in both sets above is partitioned and aggregated by time period, (by month, for example) and plotted over time to illustrate the time-varying ratio (or distribution) of MSCF fraud to all types of fraud over the event window time. The ratio or distribution so computed represents the baseline distribution of MSCF fraud within the universe of fraud types in the industry, and since compromised account transactions were excluded, this represents a distribution of the industry fraud profile that would have occurred had the compromise event never happened. The chart 600 shown in FIG. 6 illustrates one such sample distribution, where line 610 shows the proportion of MSCF-type fraud among all fraud types (event-related account data excluded). In chart 600, an exemplary report was received by the financial service provider in March '06, and an event window 620 had been established from April '05 to ‘April 06, which was 12 months before, and one month after the month in which the notice of account compromise was received. Examining one data point on trend line 610, during December '05 on chart 600, the proportion MSCF-type fraud constituted just slightly less than 20% of all fraud types reported during that month.

Returning to FIG. 4, a third set of data is extracted in the next step 435, and this set represents MSCF-type fraudulent transactions that occurred during the event window, where the extracted data is limited to transactions involving accounts that were compromised during the compromise event. Likewise, in step 440 a fourth set of data is extracted, where the data represents reported fraudulent transactions of all types during the event window for the accounts involved in the compromise event. Unlike the first two data sets, the third and fourth data sets are created to analyze fraud trends related to accounts that were accessed during the compromise event. In one embodiment, also excluded from both the third and the fourth data sets is fraud of any type involving the compromised accounts that had been associated with a separate, unrelated compromise event that may have happened to occur within the event window. However, in one embodiment, if two different compromise events occurred within a short time span of each other, for instance within 30 days, then data from both compromise events may be extracted and liability computed and apportioned for both events.

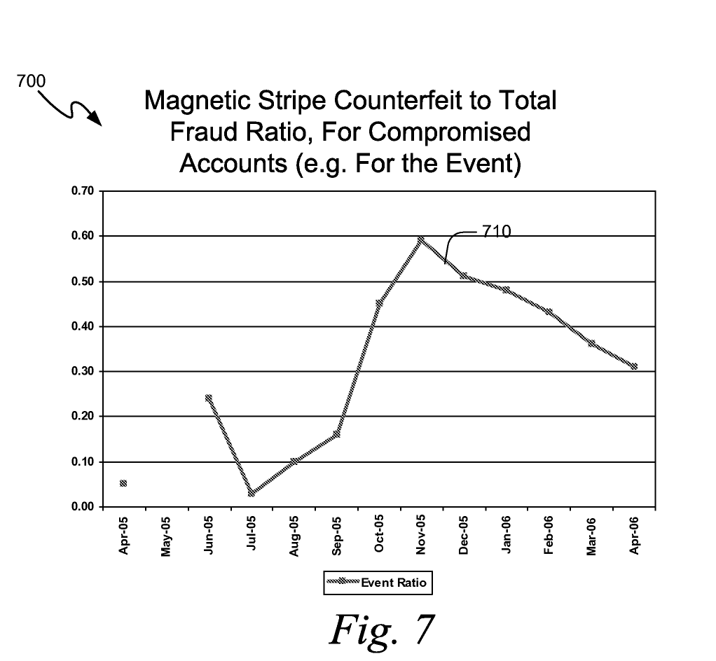

As an optional step, a second ratio 442 may be computed from the third and fourth sets to produce a distribution illustrating the proportion of MSCF-type fraud to all fraud types within the reported accounts during the fraud window. Similarly to step 430, in one embodiment, the data extracted in sets three and four is partitioned and aggregated by time period, (by month, for example) and plotted over time to illustrate the time-varying ratio (or distribution) of MSCF-type fraud to all types of fraud over the event window time for the compromised accounts. The ratio or distribution so computed represents the distribution of MSCF-type fraud only within the accounts reported in the compromise event report. The chart 700 shown in FIG. 7 illustrates one such sample distribution, where distribution plot 710 shows the proportion of MSCF-type fraud among all fraud types only for accounts that were accessed during the compromise event. As in chart 600, the data shown plotted on distribution plot 710 in chart 700 represent an exemplary situation where a compromise event report was received by the Financial Service Provider 100 in March '06, and an event window had been established from April '05 to ‘April 06. Examining one data point on distribution plot 710, during November '05 on chart 700, the proportion MSCF-type fraud constituted approximately 60% of all fraudulent transactions attributed to accounts that were accessed during the compromise event. From analyzing the shape of the distribution plot 710 one of skill in the art may conclude that a compromise event probably did occur at some period of time prior to September '05 (the first point that the distribution began to substantially change towards a larger proportion of MSCF-type fraud).

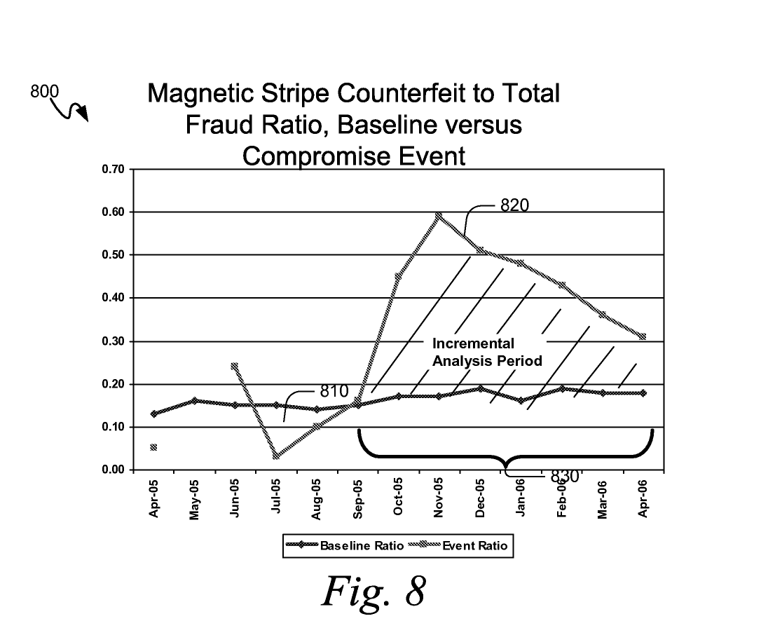

Returning to FIG. 4, the next steps comprise an analysis to determine whether the proportion of MSCF-type fraud events for the accounts accessed during the compromise event is dissimilar enough from the baseline industry fraud distribution to infer that the variation is not due to chance (step 445). Put another way, if the account data accessed during the compromise event had not been used to create counterfeit cards and produce fraudulent transactions, then the distributions of MSCF-type fraud for the accessed accounts should be substantially similar to the industry-wide baseline MSCF-type fraud to all type ratio. In one embodiment, the two distributions between account data and industry baseline ratios are compared (for instance, graphically) to identify trend differences and spot likely periods of time during the event window where the amount of MSCF-type fraud reported for the compromised accounts is likely due to use of the misappropriated data (step 450). Consider, for example, chart 800 in FIG. 8, where the two previous graphs 600 (FIG. 6) and 700 (FIG. 7) have been superimposed. The distribution of the MSCF fraud ratio for the compromised accounts, plotted on distribution 710, varies substantially from the baseline 610 MSCF ratio, and in the period from September, '05 until April '06 (identified by range 810) the proportion of MSCF-type fraud attributed to the compromised accounts comprises a substantially greater proportion of the total fraud for the compromised accounts than did the industry baseline 810. Therefore range 810 may be used to assess transactions for liability apportionment, as there is substantial confidence that during this interval of time, a substantial proportion of fraud that was being reported for the compromised accounts was a direct result of the unauthorized account data access during the compromise event. The range 810 may span a period of time less than or equal to the event window 620. Also examination of the two graphs may lead to the conclusion that liability apportionment should proceed through a method implementation, as the variation of the two ratios appears to be much greater than pure chance.

In an alternate implementation, rather than graphically comparing fraud ratio distributions, statistical testing may be used to identify whether the variation in the fraud data sets is due to pure chance, or whether the differences arise to a statistically significant variation (at step 450). In such case, well-known statistical testing techniques such as the chi-square statistic, Student's t-test (or t-statistic) or F-test may be utilized to compute numerically whether the variation in distributions is not due entirely to chance. The statistical techniques may be applied over an entire data set or piecewise over time-limited data such as monthly increments of fraudulent transaction data.

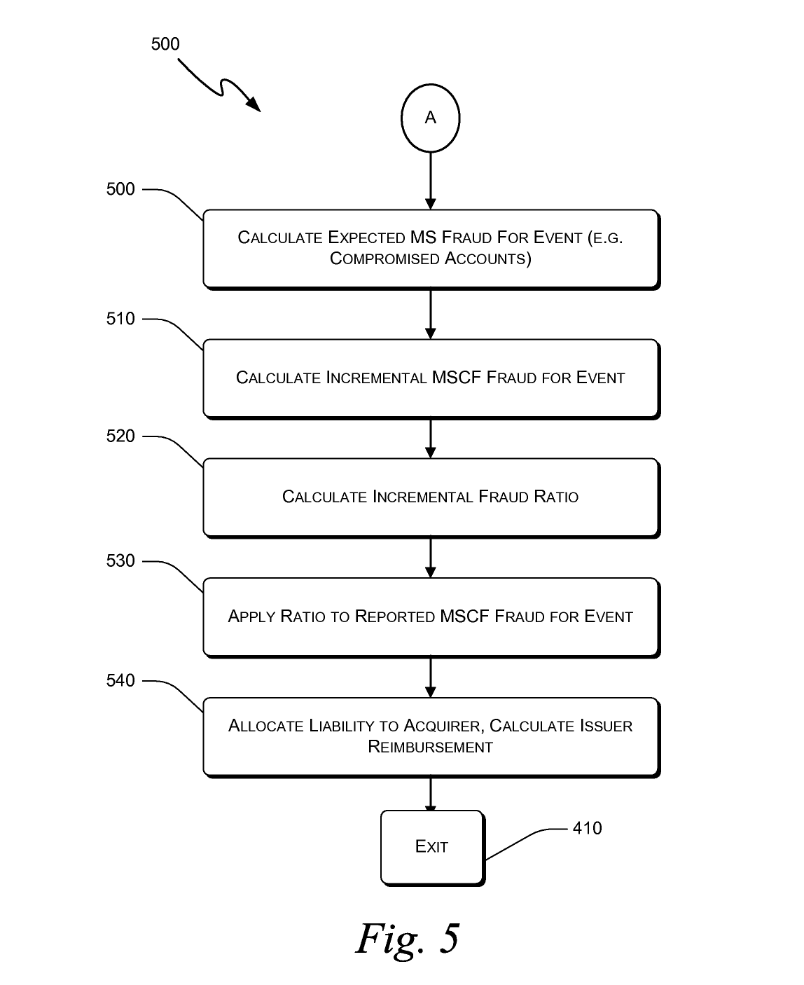

Returning to FIG. 4, at step 450, if the variation between the account fraud data and the baseline fraud data is due to chance, then an alternate technique may be used to apportion liability, if any, for account data compromise and the process terminates 410. Otherwise, the process continues with calculation of fraud apportionment in FIG. 5. In step 500, an “expected” level of fraud is calculated for the event, that is, for the compromised accounts. To calculate the expected amount of fraud, data from the fourth data set, namely the total reported fraud losses for the compromised accounts during the account window is multiplied by the industry baseline MSCF-type fraud ratio (discussed above in relationship to FIG. 6 and step 430 on FIG. 4.)

In one embodiment, the ratio calculations and multiplications are conducted in piecewise fashion for fraud data reported during discrete time intervals, for instance monthly. In an alternate embodiment, the computations may be performed on aggregate fraud data accumulated over the entire fraud interval. Since the MSCF-type fraud ratio may be viewed as a probability of occurrence of fraud, the result of the product of the baseline MSCF ratio and the total reported account fraud is an amount of fraud that would have been expected to have been reported for the compromised accounts had the compromise event not occurred. Logically, by comparing the “expected” fraud in the compromised accounts to the actual reported fraud for the compromised accounts, then a difference can reasonably be attributed to incremental fraud arising from the compromise event. In one embodiment, therefore, the incremental fraud amounts are computed in a piecewise manner on the same time reporting intervals as the expected fraud amounts, and the amount of incremental fraud is computed by subtracting the total expected MSCF-type fraud amount for the compromised accounts during that interval from the total reported MSCF-type fraud for the compromised accounts during the same interval. The result of each piecewise subtraction may then be summed to produce a total incremental amount of fraud to be assigned to the proper entity, for example, to the acquirer whose merchant was the source of the compromised data.

Continuing with step 520, an incremental fraud ratio may be computed by dividing the incremental fraud for the compromised accounts that resulted from step 510 by the total actual reported fraud for the compromised accounts over the event window. This incremental fraud ratio can then be multiplied an amount of reported MSCF-type fraud for the compromise event at step 530 to determine the amount of fraud that was attributable to the compromise event, and therefore payable by the responsible entity (at step 540) (for instance the acquirer whose merchant was compromised). For instance, if an issuer reported a total of $10,000.00 of fraud from its accounts that happened to be accessed during the compromised event, and if the incremental fraud ratio was computed to be 65%, then the issuer should be reimbursed $6,500.00 by the responsible entity.

To express the computations symbolically, let Ai represent the first data set (the total industry MSCF-type fraud, exclusive of compromised accounts), Bi represent the second data set (total industry fraud losses of all types, exclusive of compromised accounts), and BRi represent the baseline fraud ratio, where i is an index referencing a particular time interval, for instance a particular month in the event window, where i may range from zero to an infinite number. The time-varying baseline fraud ratio is computed piecewise (forming a distribution over the event window) by the division BRᵢ=Aᵢ/Bᵢ. Likewise, let Cᵢ represent the third data set (the MSCF-type fraud reported for the compromised accounts), Dᵢ represent the fourth data set (total reported fraud losses for the compromised accounts), and IRᵢ represent the incremental fraud ratio, where i is an index referencing a particular time interval, for instance a particular month in the event window, where i may range from zero to an infinite number. Then the time-varying incremental fraud ratio is similarly computed in a piecewise manner (forming a distribution over the event window) by the division IRᵢ=Cᵢ/Dᵢ. The expected fraud Fᵢ for the compromised accounts is computed as Fᵢ=Dᵢ*BRᵢ. The total incremental fraud I is then calculated as

$$I = {\sum }_{i = j}^{k} ( {C}_{i} - {F}_{i} ) ,$$

where j is the first month in an incremental analysis interval (for instance September '05 on chart 800, FIG. 8) and k is the final month in an incremental analysis interval (for instance April '06 on chart 800, FIG. 8) (where j, k,
may range from zero to infinity). Since the total actual reported fraud is

$$AR = {\sum }_{i = j}^{k} ( {C}_{i} ) ,$$

then IFR, the incremental fraud ratio, is

$$I F R = I / AR = [ {\sum }_{i = j}^{k} ( {C}_{i} - {F}_{i} ) ] / [ {\sum }_{i = j}^{k} ( {C}_{i} ) ] .$$

As an example implementation, consider the chart in FIG. 8. The compromise event report date was in March of 2006, and an exemplary window was established, as shown 620 from a date in April 2005 until a date in April 2006. As described above, a relevant period for computing incremental fraud liability is set from a date in September of 2005 until April of 2005. Over the interval, an exemplary amount of total amount of incremental MS fraud was summed from September '05 until April '05, through taking the sum of

$$I = {\sum }_{i = j}^{k} ( {C}_{i} - {F}_{i} ) ,$$

producing a value of $4,900,906.00. Over the same interval of September '05 until April '05, the total amount of actual reported magnetic-stripe counterfeit fraud related to the compromised accounts is computed as

$$AR = {\sum }_{i = j}^{k} ( {C}_{i} ) = \$7 \text{,} 597 \text{,} 205.00 .$$

Therefore, the incremental ratio to be applied to each issuer's report amounts is

$$\begin{matrix}I F R = I / AR \\ = [ {\sum }_{i = j}^{k} ( {C}_{i} - {F}_{i} ) ] / [ {\sum }_{i = j}^{k} ( {C}_{i} ) ] \\ = \$4 \text{,} 900 \text{,} 906.00 / \$7 \text{,} 597 \text{,} 205.00 . \\ = 64.5 \% .\end{matrix}$$

Then, for an additional application example, say issuer XYZ Bank had accrued $50,000.00 of magnetic stripe fraud from September '05 until April '05 for its accounts that were among those reported in the compromise event report. XYZ's eligible recovery amount for this event is $50,000.00×64.5%, or $32,250.00. That is, under a method implementation, XYZ may make a claim for recovery of $32,250.00; and this amount of liability may be assigned to a responsible party, say the acquirer whose merchant's data was compromised. Those of skill in the art may further understand that certain administrative fees or allowances may be deducted from the $32,250 recovery amount to handle administrative or handling expenses, and certain minimum payment thresholds may be applied before a recovery payment takes place.

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method comprising:
receiving, at a first time, a transmission containing a report of unauthorized access to financial account information of one or more accounts sufficient for completing one or more financial transactions using the financial account information, wherein the completed one or more financial transactions define a first fraud type; and
for a predetermined period extending before and after the first time, quantifying a set of amounts including:
without using the financial information of the one or more accounts:
all types of fraud; and
only the first fraud type;
and
using only of the financial information of the one or more accounts:
all types of fraud; and
only the first fraud type;
and
deriving, for a set of fraudulent financial transactions occurring within the predetermined period using the financial account information of the one or more accounts, a total settlement reimbursement amount from the quantified set of amounts.

2. The method as defined in claim 1, wherein, prior to the deriving, determining that a predetermined threshold is exceeded by each, or a combination thereof, of the quantified set of amounts.

3. The method as defined in claim 1, further comprising calculating an issuer reimbursement for each issuer issuing one or more of the accounts by:
deriving an issuer fraud amount for all the types of fraud, for the predetermined period, for the one or more the accounts issued by the issuer;
deriving a weighting from the quantified set of amounts; and
deriving the issuer reimbursement using:
the weighting and
the issuer fraud amount.

4. The method as defined in claim 1, wherein each of the one or more accounts corresponds to a financial instrument selected from the group consisting of:
an ATM card;
a debit card;
a money order;
a revolving credit card;
a nonrevolving credit card;
a gift card;
a wire transfer order;
a travelers cheque; and,
a combination of the foregoing.

5. The method as defined in claim 1, further comprising formatting a transmission to an entity to whom liability is to be applied, the transmission including at least the total settlement reimbursement amount.

6. A method comprising:
receiving a report of a compromise event including a date and one or more compromised accounts;
establishing an event window based upon a predetermined period of time beginning before and ending on or after the date;
determining, over the event window, a first financial fraud distribution of a first fraud type within a plurality of fraud types, wherein the first financial fraud distribution is computed from fraudulent transaction data excusive of the compromised accounts;
determining, over the event window, a second financial fraud distribution of the first fraud type within the plurality of fraud types, wherein the second financial fraud distribution is computed from fraudulent transaction data inclusive only of the compromised accounts;
comparing the first and second financial fraud distributions to a threshold criterion, wherein a determination is made that the second financial fraud distribution is not attributable to chance variation;
determining, over the event window, an incremental amount of fraud wherein a difference is computed between:
a reported amount of fraud of the first fraud type attributable to the compromise event; and,
an expected amount of fraud of the first fraud type attributable to the compromise event based upon an industry fraud baseline;
producing a ratio of the incremental amount of fraud to the reported amount of fraud attributable to the compromise event;
and
calculating an amount of fraud liability by multiplying the ratio times an amount of accumulated fraud corresponding to:
the compromise event; and
occurring within the event window.

7. The method, as defined in claim 6, wherein the determining a second financial fraud distribution further comprises suppression of all transactions corresponding to the compromised accounts whereby the transactions:
occurred within the event window and before the date; and
corresponded to a disparate compromise event from the compromise event.

8. The method as defined in claim 6, wherein the industry fraud baseline comprises an amount of fraud attributable to the first financial fraud distribution over the event window.

9. The method as defined in claim 6, wherein the comparing step further comprises determining statistical significance of variation of the second financial fraud distributions from the first financial fraud distributions through computing a Student t-statistic.

10. The method as defined in claim 6, wherein the comparing step further comprises determining statistical significance through a computing a chi-square-statistic.

11. The method as defined in claim 6, wherein the amount of fraud liability is apportioned in according to a pro-rata amount of the fraud of the first type reported by a plurality of financial institutions.

12. The method as defined in claim 6, wherein the calculating an amount of fraud liability further comprises adding an administrative overhead fee resulting from the multiplication of a constant times a number of compromised accounts corresponding to the compromise event.

13. A system comprising:
a database including:
financial transactions for a plurality of accounts; and
information for each the account;
a network;
a computing device in communication with the database and the network;
means, using the computing device, for receiving, at a first time, a transmission containing a report of unauthorized access to financial account information of one or more accounts sufficient for completing one or more financial transactions using the financial account information, wherein the completed one or more financial transactions define a first fraud type; and
means, using the computing device, for a predetermined period extending before and after the first time, for quantifying a set of amounts including:
without using the financial account information of the one or more accounts:
all types of fraud; and
only the first fraud type;
using only of the financial information of the one or more accounts:
all types of fraud; and
only the first fraud type;
and
means, using the computing device, for deriving, for a set of fraudulent financial transactions occurring within the predetermined period using the financial account information of the one or more accounts, a total settlement reimbursement amount from the quantified set of amounts.

14. The system as defined in claim 13, wherein the receiving means comprises a web-enabled database with a secured networked protocol, wherein a designated user may login and upload the financial account information through an encrypted interface.

15. The system as defined in claim 14, wherein the encrypted interface is implemented using a Secure Sockets Layer protocol.

16. The system as defined in claim 14, wherein the deriving means comprises:
means, with only the one or more accounts, for calculating a total reported amount of fraud of the first fraud type;
means, without the one or more accounts, for calculating a ratio of a total amount of the first fraud type to a total amount of the all types of fraud;
means for calculating a total expected fraud of the first type amount by multiplying the ratio by a total of the quantified amounts of only the first fraud type, whereby only the one or more accounts comprise the data utilized in the quantified amounts;
means for determining an incremental fraud amount whereby the total expected fraud of the first type amount is subtracted from the reported amount of fraud of the first fraud type;
means for dividing the incremental fraud amount by the total reported amount of fraud of the first fraud type, producing a liability ratio,
and
means for multiplying the liability ratio times an amount of fraudulent transactions from the quantified amounts.

17. The system as defined in claim 14, wherein the quantifying means further comprises:
means for accessing the database to retrieve a set of data corresponding to fraudulent transactions occurring during the predetermined period;
and
means for summing the retrieved data to produce total amounts:
without using the financial account information of the one or more accounts:
all types of fraud; and
only the first fraud type;
using only of the financial information of the one or more accounts:
all types of fraud; and
only the first fraud type.

18. The system as defined in claim 14, wherein each of the one or more accounts corresponds to a financial instrument selected from the group consisting of:
an ATM card;
a debit card;
a money order;
a revolving credit card;
a nonrevolving credit card;
a gift card;
a wire transfer order;
a travelers cheque; and,
a combination of the foregoing.

19. In a network having a computing device in communication with a database including financial transactions for a plurality of accounts and information for each the account, a system comprising:
means for receiving a report of a compromise event including a date and one or more compromised said accounts;
means for establishing an event window based upon a predetermined period of time beginning before and ending on or after the date;
means for determining, over the event window, a first financial fraud distribution of a first fraud type within a plurality of fraud types, wherein the first financial fraud distribution is computed from fraudulent transaction data excusive of the compromised accounts;
means for determining, over the event window, a second financial fraud distribution of the first fraud type within the plurality of fraud types, wherein the second financial fraud distribution is computed from fraudulent transaction data inclusive only of the compromised accounts;
means for comparing the first and second financial fraud distributions to a threshold criterion, wherein a determination is made that the second financial fraud distribution is not attributable to chance variation;
means for determining, over the event window, an incremental amount of fraud wherein a difference is computed between:
a reported amount of fraud of the first fraud type attributable to the compromise event; and,
an expected amount of fraud of the first fraud type attributable to the compromise event based upon an industry fraud baseline;
means for producing a ratio of the incremental amount of fraud to the reported amount of fraud attributable to the compromise event; and
means for calculating an amount of fraud liability by multiplying the ratio times an amount of accumulated fraud corresponding to:
the compromise event; and
occurring within the event window.

20. The system as defined in claim 19, wherein the determining means for the second financial fraud distribution further comprises means for suppression of all transactions corresponding to the compromised accounts whereby the transactions:
occurred within the event window and before the date; and
corresponded to a disparate compromise event from the compromise event.

21. The system as defined in claim 19, wherein the industry fraud baseline comprises an amount of fraud attributable to the first financial fraud distribution over the event window.

22. The system as defined in claim 19, wherein the means for comparing further comprises means for determining statistical significance of variation of the second financial fraud distributions from the first financial fraud distributions through computing a Student t-statistic.

23. The system as defined in claim 19, wherein the means for comparing further comprises means for determining statistical significance through a computing a chi-square-statistic.

24. The system as defined in claim 19, wherein the amount of fraud liability is apportioned in according to a pro-rata amount of the fraud of the first type reported by a plurality of financial institutions.

25. The system as defined in claim 19, wherein the means for calculating an amount of fraud liability further comprises means for adding an administrative overhead fee resulting from the multiplication of a constant times a number of compromised accounts corresponding to the compromise event.
